(19) United States
(12) Patent Application Publication
(10) Pub. No.: US 2006/0097038 A1
(43) Pub. Date: May 11, 2006

(54) IC card data chain

(75) Inventors: Chin-Tang Huang, Tainan Hsien (TW); Ching-Tu Shih, Changhua Hsien (TW)

Correspondence Address: BACON & THOMAS, PLLC, 625 SLATERS LANE, FOURTH FLOOR, ALEXANDRIA, VA, 22314, US

(73) Assignee: Tonic Fitness Technology, Inc., Tainan Hsien (TW)

(21) Appl. No.: 10/981,492

(22) Filed: Nov. 5, 2004

(51) Int. Cl. G06K 5/00

(52) U.S. Cl. 235/380

(57) ABSTRACT

An IC card data chain stores each datum formed in a data chain by utilizing an index read-and-write rule so that the IC card data chain has multi-functions.

### BACKGROUND OF THE INVENTION

1. Field of the Inventin

This invention relates to an IC card data chain, particularly to one having multi-functions by storing each item of index datum in an IC card with a planned regulatory form to make up a data chain by utilizing an index read-and-write rule. So various data to be stored in the IC card data chain can be assorted in a variety of items readily designed and matched to necessity to make the IC card data chain provided with multi-functions.

2. Description

Conventional IC cards have a read-and-write function, but its storing way is not regulated or stored in a solid location so that the stored data are prone to be easily accessible. In addition, the data are stored in only one item, not diversified and accordingly limited in its function,

### SUMMARY OF THE INVENTION

This invention has been devised to offer an IC card data chain with multi-functions so that it can be used for storing data assorted in plural items to be readily designed and matched to necessity.

The feature of the invention is storing by means of a planned regulated form for each index datum to be stored in a variety of items to make up a data chain to let the IC card provided with multi-functions.

### BRIEF DESCRIPTION OF DRAWINGS

This invention will be better understood by referring to the accompanying drawings, wherein:

FIG. 1 is an upper view of an IC card in the present invention; and,

FIG. 2 is a position arranging view of a data chain of the IC card in the present invention.

### DETAILED DESCRIPTION OF THE PREFERRED EMBODIMENT

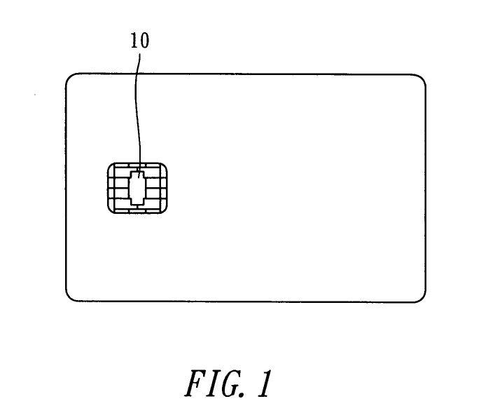

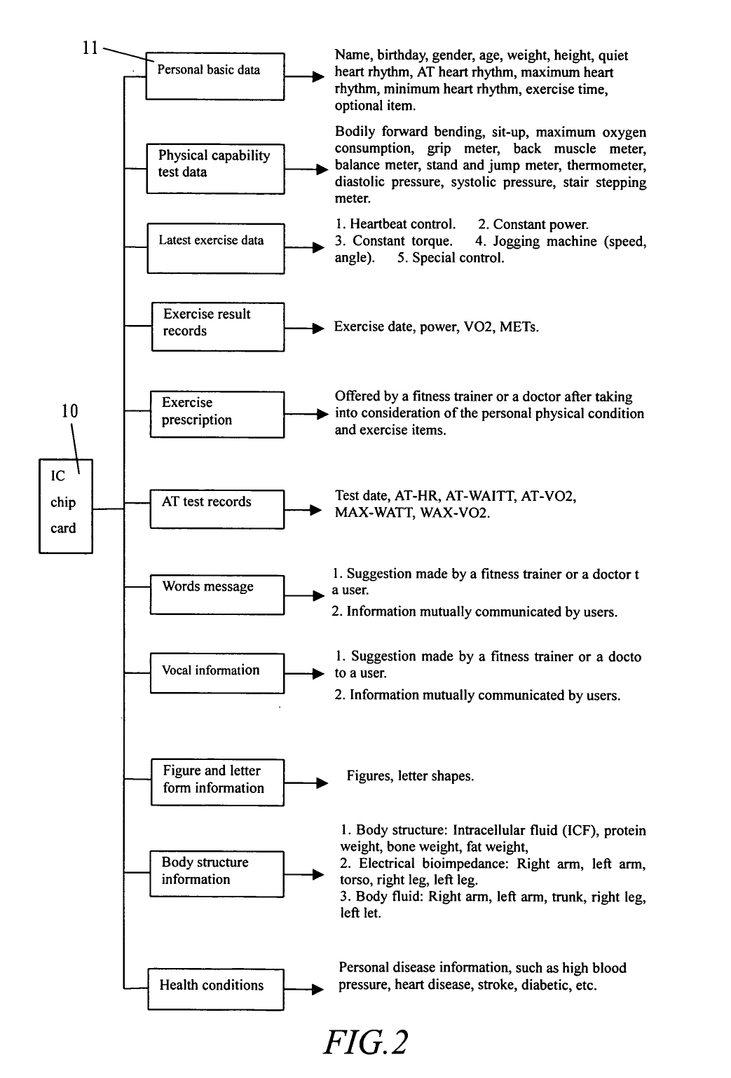

A preferred embodiment of an IC card data chain in the present invention, as shown in FIGS. 1 and 2, includes an IC card 10 with a memory for storing data by means of a read-and-write rule, and the data are assorted into a variety of items according to the three ones described below.
1. The variety of items 11: including many “items of data” as shown in FIG. 2, such as exercise conditions, which involves “personal data”, “physical adaptability”, “latest exercise data” . . . etc. When a person wants to read and write a certain datum in the IC card, the person has to look for the kind of datum in the index area.

2. The starting location: This is an address of storing location of the practical datum. When the item a datum is to be stored in is found in the index, a user can begin to make a read or write the datum at the staring location and directed to the address.

3. Unit numbers of the data: Indicating the unit numbers of data to be stored in “the variety of items”. Each “item” can store many unit numbers of data.

Besides, the formula of data to be stored in the IC card has the following.
1. Letter string: To be stored in ASCII (American Standard Code for Information Interchange) data of personal identification number, name, code, for example, 4D 41 47 30 for “MAGO”, C6 C0 41 B0 F3 for “Huang Chin Tang”.
2. Numerical string: To be stored in one byte, such as the storing date, the card number, etc.
3. Number value: To be stored in numerals by the hexadecimal system, for example, body weight, height, power: for example,
(3-1) 9 for indicating the datum being a one-digit integer,
(3-2) 999 for indicating the datum being a three-digit integer,
(3-3) 99.9 for indicating the datum being three digits and one decimal,
(3-4) 999.9 for indicating the datum being four digits and one decimal.
4. Byte: To be stored in original byte, such as figure, letter shape, etc.

This invention makes utilization of the index read-and-write rule, assorting and storing each datum in the varieties of items to make up a data chain, so that the contents an IC card stores may be diversified, and the items of data to be stored can be designed and matched readily to be applied to a fitness club, with the IC cards managed with different modes, different customers classes and equipment using classes. Then when a customer (user) inserts his/her IC card in a fitness appliance, which then decides if the possessor of the IC card can be permitted to use or not. The fitness appliance can read the personal data of the exerciser, and also can write the exercise results in the IC card. Therefore, it is evident that the IC card data chain in the invention can be applied to diversified, humanized and progressive functions.

While the preferred embodiment of the invention has been described above, it will be recognized and understood that various modifications may be made therein and the appended claims are intended to cover all such modifications that may fall within the spirit and scope of the invention.

What is claimed is:

1. An IC card data chain comprising three data of “variety of items”, “staring location” of the address of the data stored and directing to the “variety of items”, and “unit number of data” for indicating the unit number of the data by operating an index read-and-write rule, said “variety of items” possible to be readily designed and matched to necessity to let said IC card used in many varied ways.

2. The IC card data chain as claimed in claim 1, wherein if data to be stored are letter strings, they are stored in ASCII, and numerical strings is stored by two digits as one byte, and number values is stored by the hexadecimal system and bytes are stored as the original one.
